(19) United States
(12) Patent Application Publication
(10) Pub. No.: US 2007/0127592 A1
(43) Pub. Date: Jun. 7, 2007

(54) Apparatus and method for transmitting/receiving a signal in a communication system

(75) Inventors: Ye-Hoon Lee, Suwon-si (KR); Dong-Ho Kim, Seoul (KR); Yeheskel Bar-Ness, Newark, NJ (US); Kodzovi Acolatse, Newark, NJ (US)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); NEW JERSEY INSTITUTE OF TECHNOLOGY, Newark, NJ (US)

(21) Appl. No.: 11/603,857

(22) Filed: Nov. 22, 2006

Related U.S. Application Data
(60) Provisional application No. 60/739,040, filed on Nov. 22, 2005.

(51) Int. Cl. H04L 27/00; H04K 1/10

(52) U.S. Cl. 375/299; 375/260

(57) ABSTRACT

An apparatus for transmitting a signal in a communication system includes: M_{T} number of transmission antennas; a space-time encoder for generating M_{T} number of transmission symbol streams by space-time encoding M_{T} number of modulation symbol streams in accordance with a space-time encoding scheme determined by a predetermined control, and transmitting each of the M_{T} transmission symbol streams through a corresponding transmission antenna from among the M_{T} transmission antennas; and a controller for determining the space-time encoding scheme based on an iteration number of transmission, which indicates the number of times by which an information data bit stream corresponding to the M_{T} modulation symbol streams has been transmitted.

### BACKGROUND OF THE INVENTION

1. Field of the Invention

The present invention relates to a communication system, and more particularly to an apparatus and a method for transmitting/receiving a signal in a communication system.

2. Description of the Related Art

Communication systems are continuously developing in order to provide a service for high speed and large capacity signal transmission to terminals. However, channel environment of a communication system has various environmental factors, such as multi-path interference, shadowing, electric wave attenuation, time-varying noise, interference, and fading, which inevitably cause errors, thereby causing a loss of information data. The loss of information data causes severe distortion of the actual transmission signal, thereby degrading the general performance of the communication system. Therefore, in order to reduce the loss of information data and improve the reliability, the communication system employs various schemes, which include a diversity scheme and a Hybrid Automatic Repeat reQuest (HARQ) scheme. Hereinafter, the diversity scheme and the HARQ scheme will be briefly described.

First, the diversity scheme will be discussed.

The diversity scheme is used mainly in order to prevent the occurrence of errors due to fading, and can be briefly classified into a time diversity scheme, a frequency diversity scheme, and an antenna diversity scheme (a space diversity scheme). The antenna diversity scheme refers to a scheme using multiple antennas, which can be classified into a reception antenna diversity scheme using multiple reception antennas, a transmission antenna diversity scheme using multiple transmission antennas, and a Multiple Input Multiple Output (MIMO) scheme using multiple reception antennas and multiple transmission antennas. The MIMO scheme is a kind of Space-Time Coding (STC) scheme, which transmits signals coded according to a predetermined coding scheme through multiple antennas, so as to expand the coding scheme of the time domain to that of the space domain, thereby achieving a reduced error rate.

Second, the HARQ scheme will be discussed.

The HARQ scheme is a scheme employing advantages of both the Automatic Repeat reQuest (ARQ) scheme and the Forward Error Correction (FEC) scheme. According to the HARQ scheme, when there is an error in the information data received by a signal reception apparatus, the signal reception apparatus is requested to re-transmit the erroneous information data. Therefore, the HARQ scheme has improved reliability due to the re-transmission. Further, the HARQ scheme can be classified into a Chase Combining (CC) scheme and an Incremental Redundancy (IR) scheme.

Therefore, simultaneous use of the MIMO scheme and the HARQ scheme is now being considered for communication systems. Hereinafter, a scheme for the simultaneous use of the MIMO scheme and the HARQ scheme will be referred to as “MIMO-HARQ scheme,” for convenience of description. In the case of the MIMO-HARQ scheme proposed up to now, only a flat fading channel environment is considered for the channel environment. However, because the channel environment of an actual communication system corresponds to a frequency selective fading channel environment, it is impossible to guarantee the performance of an actual communication system employing the MIMO-HARQ scheme considering only the flat fading channel environment. Therefore, there has been a necessity for a scheme for transmitting/receiving a signal according to a MIMO-HARQ scheme considering the frequency selective fading channel environment of an actual system.

### SUMMARY OF THE INVENTION

Accordingly, the present invention has been made to solve the above-mentioned problems occurring in the prior art, and an object of the present invention is to provide an apparatus and a method for transmitting/receiving a signal according to a MIMO-HARQ scheme in a communication system.

It is another object of the present invention to provide an apparatus and a method for signal transmission/reception in a communication system, which uses a MIMO-HARQ scheme in consideration of frequency selective channel environment.

In order to accomplish this object, there is provided an apparatus for transmitting a signal in a communication system, the apparatus including: M_{T} number of transmission antennas; a space-time encoder for generating M_{T} number of transmission symbol streams by space-time encoding M_{T} number of modulation symbol streams in accordance with a space-time encoding scheme determined by a predetermined control, and transmitting each of the M_{T} transmission symbol streams through a corresponding transmission antenna from among the M_{T} transmission antennas; and a controller for determining the space-time encoding scheme based on an iteration number of transmission, which indicates the number of times by which an information data bit stream corresponding to the M_{T} modulation symbol streams has been transmitted.

In accordance with another aspect of the present invention, there is provided an apparatus for receiving a signal in a communication system, the apparatus including: M_{R} number of reception antennas; M_{R} number of Fast Fourier Transform (FFT) units connected to the reception antennas, so as to receive signals transmitted through M_{T} number of transmission antennas of a signal transmission apparatus corresponding to the apparatus for receiving a signal, and to perform FFT on the received signals; a signal detector for generating an incoming signal vector by linearly combining signals output from the M_{R} FFT units, detecting signals from the incoming signal vector according to a predetermined signal detection scheme, and separately outputting M_{T} number of detected signals in accordance with the M_{T} transmission antennas of the signal transmission apparatus; M_{T} number of Inverse Fast Fourier Transform (IFFT) units for performing IFFT on the signals output from the signal detector; and M_{T} number of demodulators for demodulating signals output from the IFFT units according to a demodulation scheme corresponding to a modulation scheme used in the signal transmission apparatus.

In accordance with another aspect of the present invention, there is provided a method for transmitting a signal by a signal transmission apparatus in a communication system, the method including the steps of: generating M_{T} number of transmission symbol streams by space-time encoding M_{T} number of modulation symbol streams in accordance with a space-time encoding scheme determined by a predetermined control, and transmitting each of the M_{T} transmission symbol streams through a corresponding transmission antenna from among the M_{T} transmission antennas; and determining the space-time encoding scheme based on an iteration number of transmission, which indicates the number of times by which an information data bit stream corresponding to the M_{T} modulation symbol streams has been transmitted.

In accordance with another aspect of the present invention, there is provided a method for receiving a signal by a signal reception apparatus in a communication system, the method including the steps of: receiving signals transmitted through M_{T} number of transmission antennas of a signal transmission apparatus corresponding to the signal reception apparatus, and performing FFT on the received signals; generating an incoming signal vector by linearly combining the FFTed signals, detecting signals from the incoming signal vector according to a predetermined signal detection scheme, and separately outputting M_{T} number of detected signals in accordance with the M_{T} transmission antennas of the signal transmission apparatus; performing IFFT on the M_{T} detected signals; and demodulating the IFFTed signals according to a demodulation scheme corresponding to a modulation scheme used in the signal transmission apparatus.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a signal transmission apparatus having two transmission antennas (M_{T}=2) in a MIMO-HARQ communication system according to an embodiment of the present invention;

FIGS. 2a and 2b schematically illustrate structures of transmission symbol streams transmitted by the signal transmission apparatus of FIG. 1;

FIG. 3 is a block diagram illustrating an internal structure of a signal reception apparatus corresponding to the signal transmission apparatus of FIG. 1;

FIG. 4 is a block diagram of a signal transmission apparatus having three transmission antennas (M_{T}=3) in a MIMO-HARQ communication system according to another embodiment of the present invention;

FIG. 5 schematically illustrates structures of transmission symbol streams transmitted by the signal transmission apparatus of FIG. 4;

FIG. 6 is a block diagram illustrating an internal structure of a signal reception apparatus corresponding to the signal transmission apparatus of FIG. 4;

FIG. 7 is a graph showing a Bit Error Rate (BER) performance according to the number of times by which an information data bit stream is transmitted when a signal transmission apparatus uses two transmission antennas and a signal reception apparatus uses two reception antennas in a MIMO-HARQ communication system according to an embodiment of the present invention;

FIG. 8 is a graph for comparison between a performance of a MIMO-HARQ communication system according to an embodiment of the present invention, which includes a signal transmission apparatus using two transmission antennas and a signal reception apparatus using two reception antennas, uses an MMSE scheme for signal detection, and is in a frequency selective channel environment, and a performance of a typical MIMO communication system, which uses only the STBC scheme;

FIG. 9 is a graph for comparison between a performance of a MIMO-HARQ communication system according to an embodiment of the present invention, which includes a signal transmission apparatus using two transmission antennas and a signal reception apparatus using two reception antennas, uses a ZF scheme for signal detection, and is in a frequency selective channel environment, and a performance of a typical MIMO communication system, which uses only the STBC scheme;

FIG. 10 is a graph for comparison between a performance of a MIMO-HARQ communication system according to an embodiment of the present invention, which includes a signal transmission apparatus using two transmission antennas and a signal reception apparatus using two reception antennas, uses an MMSE scheme for signal detection, and is in a flat fading channel environment, and a performance of a typical MIMO communication system, which uses only the STBC scheme; and

FIG. 11 is a graph for comparison between a performance of a MIMO-HARQ communication system according to an embodiment of the present invention, which includes a signal transmission apparatus using two transmission antennas and a signal reception apparatus using two reception antennas, uses a ZF scheme for signal detection, and is in a flat fading channel environment, and a performance of a typical MIMO communication system, which uses only the STBC scheme.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention rather unclear.

The present invention proposes an apparatus and a method for transmitting/receiving a signal in a communication system (MIMO-HARQ communication system), which uses a Multiple Input Multiple Output-Hybrid Automatic Repeat reQuest (MIMO-HARQ) scheme. Especially, the present invention proposes an apparatus and a method for transmitting/receiving a signal in a MIMO-HARQ communication system that has a frequency selective fading channel environment. As described below, it is assumed that a signal transmission apparatus includes M_{T} transmission antennas and a signal transmission apparatus includes M_{R} transmission antennas in the MIMO-HARQ communication system according to the present invention. For convenience of description, the following discussion deals with only the cases when M_{T}=2 and M_{R}=3. However, it is of course possible to apply the signal transmission/reception of the MIMO-HARQ communication system proposed by the present invention to other cases as well as the cases when M_{T}=2 and M_{R}=3.

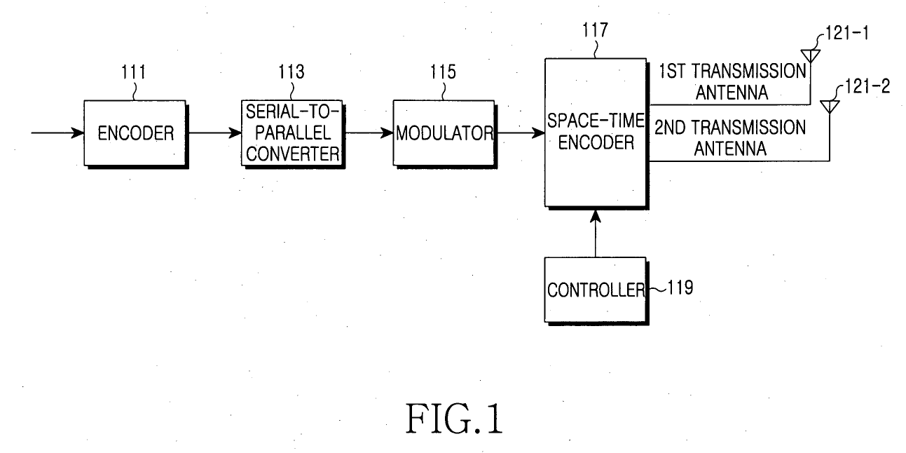

FIG. 1 is a block diagram of a signal transmission apparatus having two transmission antennas (M_{T}=2) in a MIMO-HARQ communication system according to an embodiment of the present invention.

Referring to FIG. 1, the signal transmission apparatus includes an encoder 111, a serial-to-parallel converter 113, a modulator 115, a space-time encoder 117, a controller 119, a first transmission antenna 121-1, and a second transmission antenna 121-2.

First, when an information data bit stream to be transmitted is input to the signal transmission apparatus, the information data bit stream is transferred to the encoder 111. It is assumed that the information data bit stream has a length of a, that is, the information data bit stream includes a number of information data bits. Then, the encoder 111 generates a codeword C having a length of n by encoding the information data bit stream according to a predetermined encoding scheme, and outputs the generated codeword C to the serial-to-parallel converter 113. For the predetermined encoding scheme, various codes may be used, such as a Cyclic Redundancy Check (CRC) code, which is an error detection code, and a convolution code, a turbo code, and a Low Density Parity Check (LDPC) code, which are error correction codes. Further, it is assumed that the coding scheme output from the encoder 111 considers only the error detection codes and the codeword corresponds to (n, a) CRC code. The serial-to-parallel converter 113 parallel-converts the (n, a) CRC code into two sub-blocks and outputs the converted sub-blocks to the modulator 115. It is assumed that each of the sub-blocks has a length n_{T} of

$$n / 2 ( {n}_{T} = \frac{n}{2} ) .$$

The modulator 115 generates modulation symbol streams by modulating each of the two sub-blocks output from the serial-to-parallel converter 113 according to a predetermined modulation scheme, and outputs the generated modulation symbol streams to the space-time encoder 117. For the modulation, the modulator 115 uses one modulation scheme selected from among a Binary Phase Shift Keying (BPSK) scheme having a constellation C of 2^{b}, a Quadrature Phase Shift Keying (QPSK) scheme, an 8-PSK scheme, and a 16 Quadrature Amplitude Modulation (16-QAM) scheme. Therefore, the modulator 115 modulates each of the sub-blocks having a length of n_{T} into a modulation symbol stream including N number of modulation symbols

$$( N = \frac{{n}_{T}}{b} ) .$$

The modulation symbol stream output from the modulator 115 can be defined by equation (1) below.
sᵢ=[sᵢ(0),sᵢ(1), . . . ,sᵢ(N−1)] (1)

In equation (1), i denotes a modulation symbol stream index, which has a value of 1 or 2 (i=1, 2) because the modulator 115 generates two modulation symbol streams.

The space-time encoder 117 receives the modulation symbol streams output from the modulator 115, space-time encodes the received modulation symbol streams under the control of the controller 119, and outputs the encoded streams to corresponding transmission antennas. Hereinafter, an operation of controlling the space-time encoding of the space-time encoder 117 by the controller 119 will be discussed.

First, the controller 119 controls the operation of the space-time encoder 117 based on the ACK or NACK information which the controller 119 received from a signal reception apparatus, that is, information indicating if there is an error in the information data bit stream transmitted by the signal transmission apparatus in a previous transmission time interval. Of course, when the information data bit stream is initially transmitted, the controller 119 does not take the ACK or NACK information into consideration because there is no received ACK or NACK information from the signal reception apparatus. The ACK information indicates that the signal reception apparatus has succeeded in normally restoring the information bit stream transmitted from the signal transmission apparatus and that there is no error in the information data bit stream. The NACK information indicates that the signal reception apparatus has failed to normally restore the information bit stream transmitted from the signal transmission apparatus and that there is an error in the information data bit stream. When the controller 119 receives NACK information from the signal reception apparatus, the controller 119 re-transmits a corresponding information data bit stream.

First, in the case of an odd^{th} transmission of the information data bit stream, under the control of the controller 119, the space-time encoder 117 transmits the modulation symbol streams output from the modulator 115 as they are through corresponding transmission antennas. As used herein, the odd^{th} transmission refers to transmission for an odd time, such as the first transmission (initial transmission) or the third transmission (second re-transmission). In the case of odd^{th} transmission of the information data bit stream, the transmission symbol stream output by the space-time encoder 117 to be transmitted through each transmission antenna can be defined by equation (2) below.
xⱼ^{k}=[sⱼ^{k}(0),sⱼ^{k}(1), . . . ,sⱼ^{k}(N−1)] (2)

In equation (2), j denotes a transmission antenna index, which has a value of 1 or 2 (j=1, 2) because FIG. 1 is based on use of two transmission antennas, and k denotes an index which indicates an odd^{th} transmission of the information data bit stream (k=1, 3, 5, . . . ).

That is, under the control of the controller 119, in the case of an odd^{th} transmission of the information data bit stream, the space-time encoder 117 transmits x₁^{k}=└s₁^{k}(0),s₁^{k}(1), . . . ,s₁^{k}(N−1)┘ through the first transmission antenna 121-1 and x₂^{k}=└s₂^{k}(0),s₂^{k}(1), . . . ,s₂^{k}(N−1)┘ through the second transmission antenna 121-2. In the case of an odd^{th} transmission of the information data bit stream as described above, it is noted that the transmission symbol stream transmitted through the first transmission antenna 121-1 is identical to the first modulation symbol stream s₁ output from the modulator 115 and the transmission symbol stream transmitted through the second transmission antenna 121-2 is identical to the second modulation symbol stream s₂ output from the modulator 115.

Next, in the case of an even^{th} transmission of the information data bit stream, under the control of the controller 119, the space-time encoder II 7 space-time encodes the modulation symbols output from the modulator 115 according to a Space Time Block Coding (STBC) scheme and transmits the encoded modulation symbols through corresponding transmission antennas. It is assumed that the STBC scheme is, for example, the Alamouti space time block coding scheme. That is to say, when the information data bit stream is transmitted for the second time (that is, re-transmitted for the first time), or is transmitted for the fourth time (that is, re-transmitted for the third time), the space-time encoder 117, under the control of the controller 119, transmits x₁^{k+1}=└−s₂^{k*}(0),−s₂^{k*}(N−1), . . . ,−s₂^{k*}(1)┘ through the first transmission antenna 121-1 and transmits x₂^{k+1}=└s₁^{k*}(0),s₁^{k*}(N−1), . . . ,s₁^{k*}(1)┘ through the second transmission antenna 121-2.

Therefore, the odd^{th} transmission and the even^{th} transmission of the information data have a relation as defined by equation (3) below.
x₁^{k+1}(n)=−x₂^{k*}((−n)_{N})
x₂^{k+1}(n)=x₁^{k*}((−n)_{N}) (3)

In equation (3), (.)_{N} denotes a modulo N operation. If equation (3) is converted into the frequency domain, equation (4) as defined below is obtained.
X₁^{k+1}=−X₂^{k*}
X₂^{k+1}=X₁^{k*} (4)

In equation (4), Xⱼ^{k} can be defined by equation (5) below.
Xⱼ^{k}=Q_{(N)}xⱼ^{k} (5)

In equation (5), Q_{(N)} denotes an N×N Discrete Fourier Transform (DCT) matrix.

The embodiment shown in FIG. 1 is based on an assumption that, when the information data bit stream is re-transmitted, the modulation symbol streams generated at the time of initial transmission of a corresponding information data bit stream are used as they are, without separate operations of encoding, serial-to-parallel conversion, and modulation. Therefore, in FIG. 1, it will do if only the space-time encoder 117 performs its space-time encoding operation at the time of re-transmission of a corresponding information data bit stream.

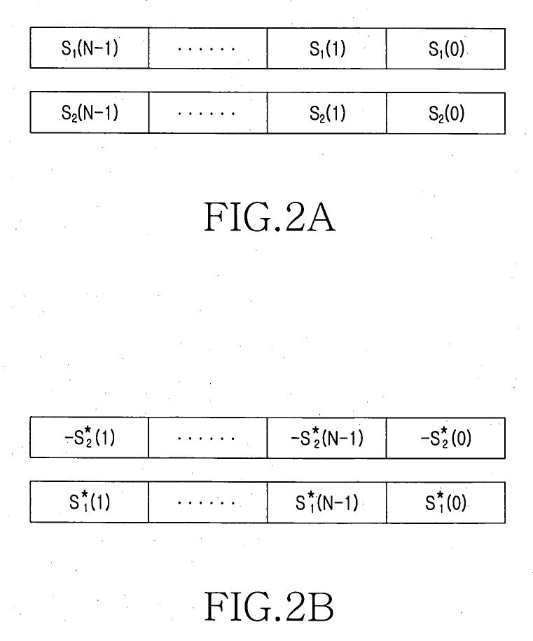

Next, structures of transmission symbol streams transmitted by the signal transmission apparatus of FIG. 1 will be described with reference to FIGS. 2a and 2b.

FIGS. 2a and 2b schematically illustrate structures of transmission symbol streams transmitted by the signal transmission apparatus of FIG. 1.

The structure shown in FIG. 2a corresponds to a structure of transmission symbol streams in the case of the k^{th} transmission (an odd^{th} transmission) of the information data bit stream, and the structure shown in FIG. 2b corresponds to a structure of transmission symbol streams in the case of the (k+1)^{th} transmission (an even^{th} transmission) of the information data bit stream.

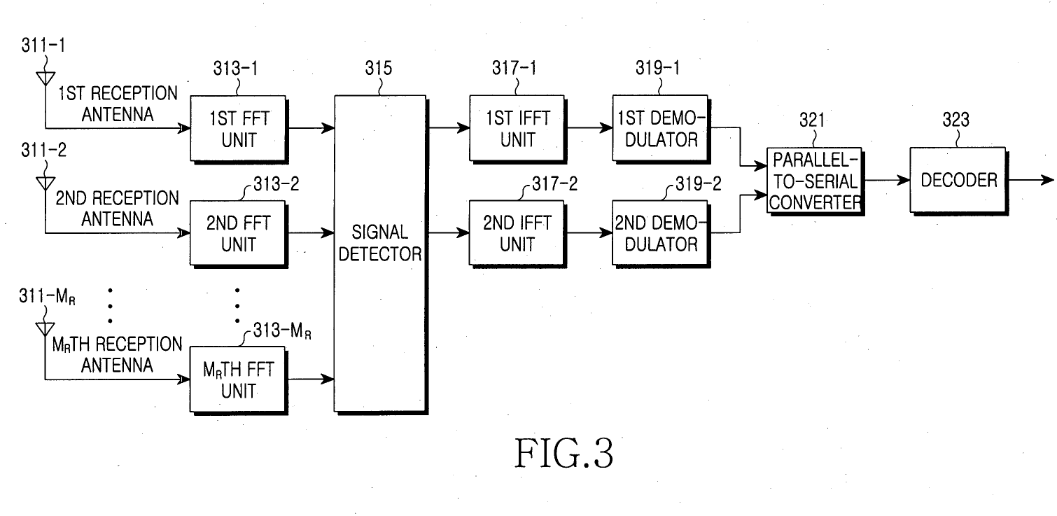

Hereinafter, an internal structure of a signal reception apparatus corresponding to the signal transmission apparatus of FIG. 1 will be described with reference to FIG. 3.

FIG. 3 is a block diagram illustrating an internal structure of a signal reception apparatus corresponding to the signal transmission apparatus of FIG. 1.

Referring to FIG. 3, the signal reception apparatus includes a plurality of reception antennas, for example, an M_{R} number of antennas including a first reception antenna 311-1 to an M_{R}^{th} reception antenna 311-M_{R}, an M_{R} number of Fast Fourier Transform (FFT) units including a first FFT unit 313-1 to an M_{R}^{th} FFT unit 313-M_{R}, a signal detector 315, two Inverse Fast Fourier Transform (IFFT) units including a first IFFT unit 317-1 and a second IFFT unit 317-2, two demodulators including a first demodulator 319-1 and a second demodulator 319-2, a parallel-to-serial converter 321, and a decoder 323.

First, when the information data bit stream has been transmitted for an odd^{th} time, that is, for the k^{th} time by the signal transmission apparatus of FIG. 1, the signals radiated from the two transmission antennas of the signal transmission apparatus are received by each of the M_{R} number of antennas, and the M_{R} number of antennas then transfer the received signals to corresponding FFT units, respectively. Specifically, the first reception antenna 311-1 outputs the received signal to the first FFT unit 313-1, the second reception antenna 311-2 outputs the received signal to the second FFT unit 313-2, and the M_{R}^{th} reception antenna 311-M_{R} outputs the received signal to the M_{R}^{th} FFT unit 313-M_{R}. Each of the first FFT unit 313-1 to the M_{R}^{th} FFT unit 313-M_{R} performs an FFT operation on the input signal and outputs the FFTed signal to the signal detector 315. At this time, a signal output from an m^{th} FFT unit can be defined by equation (6) below.
Yₘ^{k}=Λₘ₁^{k}X₁^{k}+Λₘ₂^{k}X₂^{k}+Wₘ^{k} (6)

In equation (6), m denotes an index of a reception antenna (in =1, 2, . . . , M_{R}), Λₘⱼ^{k}=diag(Q_{(N)}hₘⱼ^{k}) denotes a diagonal matrix having a channel frequency response, hₘⱼ^{k} denotes a multi-path channel impulse response from the j^{th} transmission antenna to the m^{th} reception antenna, and Wₘ^{k} denotes an FFT operation value of channel noise in the signal reception apparatus.

Meanwhile, the signal detector 315 receives and linearly combines the signals output from the first FFT unit 313-1 to the M_{R}^{th} FFT unit 313-M_{R}, and generates an incoming signal vector from the linearly combined signals. As used herein, a k^{th} incoming signal vector corresponding to the k^{th} information data bit stream is referred to as Y^{k}. When it is assumed that Y^{k}=[Y₁^{k}, Y₂^{k}, . . . , Y_{M}^{k}], Y^{k}, which is an incoming signal vector received through M_{R} number of reception antennas, can be defined by equation (7) below.
Y^{k}=Λ^{k}X^{k}+W^{k} (7)

In equation (7),

$${Λ}^{k} = [ {Λ}_{1}^{k} {Λ}_{2}^{k} ] = ( \begin{matrix}{Λ}_{11}^{k} & {Λ}_{12}^{k} \\ {Λ}_{21}^{k} & {Λ}_{22}^{k} \\ ⋮ & ⋮ \\ {Λ}_{{M}_{R} 1}^{k} & {Λ}_{{M}_{R} 2}^{k}\end{matrix} ) , \\ {X}^{k} = ( \begin{matrix}{X}_{1}^{k} \\ {X}_{2}^{k}\end{matrix} ) ,$$

and W^{k}=[W₁^{k},W₂^{k}, . . . ,W_{M}_{_{R}}^{k}]^{T}.

Meanwhile, the signal detector 315 receives the signals output from the first FFT unit 313-1 to the M_{R}^{th} FFT unit 313-M_{R} and detects the signals according to a predetermined signal detection scheme, for example, according to a Zero Forcing (ZF) scheme or a Minimum Mean Square Error (MMSE) scheme for passing the signal through a matched filter.

Hereinafter, an operation for detecting signals according to the MMSE scheme by the signal detector 315 will be discussed first.

When the signal detector 315 detects a signal according to the MMSE scheme, the detected signal can be defined by equation (8) below.

$${\hat{X}}_{mmse}^{( k )} = {( {Λ}^{( k ) H} {Λ}^{( k )} + \frac{1}{SNR} {I}_{2 N} )}^{- 1} {Λ}^{( k ) H} {Y}^{( k )} \qquad ( 8 )$$

In equation (8), \hat{X}ₘₘₛₑ^{(k)} includes \hat{X}ₘₘₛₑ₁^{(k)}, which denotes a detected signal corresponding to the signal transmitted through the first transmission antenna 121-1 of the signal transmission apparatus, and \hat{X}ₘₘₛₑ₂^{(k)}, which denotes a detected signal corresponding to the signal transmitted through the second transmission antenna 121-2 of the signal transmission apparatus. Further, in equation (8), SNR denotes a signal to noise ratio for each reception antenna of the signal reception apparatus. The signal detector 315 receives Y^{(k)}, which is an expression of the frequency domain converted by the FFT units 313 from the incoming signal received through the reception antenna units 311, and passes the received signal through the matched filter Λ^{(k)H} by using Λ^{(k)}, which is a frequency domain expression of the MIMO channel, thereby detecting the signal according to the MMSE scheme. As used herein, the matched filter can be expressed by Λ^{H}, which is a transpose conjugate of Λ, which is a frequency domain expression of the MIMO channel.

The signal detector 315 outputs \hat{X}ₘₘₛₑ₁^{(k)} to the first IFFT unit 317-1 and \hat{X}ₘₘₛₑ₂^{(k)} to the second IFFT unit 317-2. The first IFFT unit 317-1 restores a final transmission symbol stream \hat{x}₁^{k} by performing IFFT on the received \hat{X}ₘₘₛₑ₁^{(k)} and outputs the restored transmission symbol stream \hat{x}₁^{k} to the first demodulator 319-1. The second IFFT unit 317-2 restores a final transmission symbol stream \hat{x}₂^{k} by performing IFFT on the received \hat{X}ₘₘₛₑ₂^{(k)} and outputs the restored transmission symbol stream \hat{x}₂^{k} to the second demodulator 319-2.

Second, an operation for detecting a signal according to a ZF scheme by the signal detector 315 will be discussed.

A signal detected according to a ZF scheme by the signal detector 315 can be defined by equation (9) below.
\hat{x}_{ZF}^{(k)}=Λ^{(k)}+Y^{(k)} (9)

In equation (9), Λ^{(k)+}=(Λ^{(k)H}Λ^{(k)})⁻¹Λ^{(k)H}, which corresponds to a signal detection method according the ZF scheme and the frequency domain matched filter Λ^{(k)H}. In equation (9), \hat{x}_{ZF}^{(k)} includes \hat{x}_{ZF1}^{(k)}, which denotes a detection signal corresponding to the signal transmitted through the first transmission antenna 121-1 of the signal transmission apparatus, and \hat{x}_{ZF2}^{(k)}, which denotes a detection signal corresponding to the signal transmitted through the second transmission antenna 121-2 of the signal transmission apparatus.

The signal detector 315 outputs \hat{x}_{ZF1}^{(k)} to the first IFFT unit 317-1 and \hat{x}_{ZF2}^{(k)} to the second IFFT unit 317-2. The first IFFT unit 317-1 restores a final transmission symbol stream \hat{x}₁^{k} by performing IFFT on the received \hat{x}_{ZF1}^{(k)} and outputs the restored transmission symbol stream \hat{x}₁^{k} to the first demodulator 319-1. The second IFFT unit 317-2 restores a final transmission symbol stream \hat{x}₂^{k} by performing IFFT on the received \hat{x}_{ZF2}^{(k)} and outputs the restored transmission symbol stream \hat{x}₂^{k} to the second demodulator 319-2.

Then, the first demodulator 319-1 demodulates the signal output from the first IFFT unit 317-1 according to the demodulation scheme corresponding to the modulation scheme used in the modulator 115 and outputs the demodulated signal the parallel-to-serial converter 321. Further, the second demodulator 319-2 demodulates the signal output from the second IFFT unit 317-2 according to the demodulation scheme corresponding to the modulation scheme used in the modulator 115 and outputs the demodulated signal the parallel-to-serial converter 321. Then, the parallel-to-serial converter 321 converts the signals output from the first demodulator 319-1 and the second demodulator 319-2 into a serial signal and output the converted serial signal to the decoder 323. The decoder 323 decodes the signal output from the parallel-to-serial converter 321 according to a decoding scheme corresponding to the encoding scheme used by the encoder 111 of the signal transmission apparatus, thereby restoring an information data bit stream. When the decoder 323 can normally restore the information data bit stream from the signal output from the parallel-to-serial converter 321, the signal reception apparatus transmits ACK information to the signal transmission apparatus through a separate transmitter, although not shown in FIG. 3. In contrast, when the decoder 323 cannot normally restore the information data bit stream from the signal output from the parallel-to-serial converter 321, the signal reception apparatus transmits NACK information to the signal transmission apparatus.

As the signal reception apparatus transmits the NACK information for the transmission of the information data for an odd^{th} time, the signal transmission apparatus transmits the information data for an even^{th} time, that is, for the (k+1)^{th} time. As used herein, the (k+1)^{th} incoming signal vector output from the signal detector 315 is referred to as Y^{(k+1)}, which can be defined by equation (10) below.

$$\begin{matrix}{Y}^{( k + 1 )} = {Λ}_{1}^{( k + 1 )} {X}_{1}^{( k + 1 )} + {Λ}_{2}^{( k + 1 )} {X}_{2}^{( k + 1 )} + {W}^{( k + 1 )} \\ = - {Λ}_{1}^{( k + 1 )} {X}_{2}^{{( k )}^{*}} + {Λ}_{2}^{( k + 1 )} {X}_{1}^{{( k )}^{*}} + {W}^{( k + 1 )}\end{matrix} \qquad ( 10 )$$

By using equation (4), equation (10) can be converted to equation (11) as defined below.

$$\begin{matrix}{Y}^{{( k + 1 )}^{*}} = {Λ}_{2}^{{( k + 1 )}^{*}} {X}_{ 1}^{( k )} - {Λ}_{1}^{{( k + 1 )}^{*}} {X}_{2}^{( k )} + {W}^{{( k + 1 )}^{*}} \\ = {\tilde{Λ}}^{( k + 1 )} {X}^{k} + {W}^{{( k + 1 )}^{*}}\end{matrix} \qquad ( 11 )$$

In equation (11), \tilde{Λ}^{(k+1)}=Λ^{(k+1)*}Φ, wherein

$$Φ = ( \begin{matrix}0 & - 1 \\ 1 & 0\end{matrix} ) .$$

Further, the signal detector 315 generates an incoming signal vector Y by combining \tilde{Λ}^{(k+1)H}Y^{(k+1)*}, which is an output of the matched filter at the (k+1)^{th} transmission of the information data bit stream, and Λ^{(k)H}Y^{(k)}, which is an output of the matched filter at the k^{th} transmission of the information data bit stream. The incoming signal vector Y can be defined by equation (12) below.
Y=\tilde{Λ}^{(k+1)H}Y^{(k+1)*}+Λ^{(k)H}Y^{(k)*} (12)

Equation (12) can be also replaced by equation (13) as defined below.
Y=CX^{k}+Ψ (13)

In equation (13), C can be defined by equation (14) below, and Ψ can be defined by equation (15) below.
C=\tilde{Λ}^{(k+1)H}\tilde{Λ}^{(k+1)}+Λ^{(k)H}Λ^{(k)} (14)
Ψ=Λ^{(k+1)H}W^{(k+1)*}+Λ(k)HW^{(k)} (15)

Because it is assumed that the dispersion channel slowly changes in the time domain, a relation as defined by equation (16) below is established.
Λⱼ^{(k+1)}=Λⱼ^{k}=Λⱼ (16)

Therefore, it is easily noted that the matrix C is a diagonal matrix, which an be defined by equation (17) below.

$$C = ( \begin{matrix}{C}_{0} & 0 \\ 0 & {C}_{0}\end{matrix} ) \qquad ( 17 )$$

In equation (17),

$${C}_{0} ( i , i ) = {\sum }_{m = 1}^{M} {\vert {Λ}_{m 1} ( i , i ) \vert}^{2} + {\vert {Λ}_{m 2} ( i , i ) \vert}^{2} ,$$

wherein i=1, 2, . . . , N.

Further, for the combined incoming signal vector Y also, the signal detector 315 detects a signal according to the MMSE scheme or the ZF scheme.

Hereinafter, an operation for detecting a signal corresponding to the combined incoming signal vector Y according to the MMSE scheme by the signal detector 315 will be discussed first.

When the signal detector 315 detects a signal corresponding to the combined incoming signal vector Y according to the MMSE scheme, the detected signal can be defined by equation (18) below.

$${\tilde{X}}_{mmse} = {( {C}^{H} C + \frac{1}{SNR} {I}_{2 NM} )}^{- 1} {C}^{H} Y \qquad ( 18 )$$

In equation (18), \hat{X}ₘₘₛₑ includes \hat{X}ₘₘₛₑ₁, which denotes a detected signal corresponding to the signal transmitted through the first transmission antenna 121-1 of the signal transmission apparatus in the combined incoming signal vector Y, and also includes \hat{X}ₘₘₛₑ₂, which denotes a detected signal corresponding to the signal transmitted through the second transmission antenna 121-2 of the signal transmission apparatus in the combined incoming signal vector Y.

The signal detector 315 outputs \hat{X}ₘₘₛₑ₁ to the first IFFT unit 317-1 and \hat{X}ₘₘₛₑ₂ to the second IFFT unit 317-2. The first IFFT unit 317-1 restores a transmission symbol stream \hat{x}₁ by performing IFFT on the received \hat{x}ₘₘₛₑ₁, and outputs the restored transmission symbol stream \hat{x}₁ to the first demodulator 319-1. The second IFFT unit 317-2 restores a transmission symbol stream \hat{x}₂ by performing IFFT on the received \hat{X}ₘₘₛₑ₂, and outputs the restored transmission symbol stream \hat{x}₂ to the second demodulator 319-2.

Second, an operation for detecting a signal according to the ZF scheme by the signal detector 315 will be discussed.

A signal detected according to the ZF scheme by the signal detector 315 can be defined by equation (19) below.
\hat{x}_{ZF}=C⁻Y (19)

In equation (19), \hat{x}_{ZF} includes \hat{x}_{ZF1}, which denotes a detection signal corresponding to the signal transmitted through the first transmission antenna 121-1 of the signal transmission apparatus in the combined incoming signal vector Y, and also includes \hat{x}_{ZF2}, which denotes a detection signal corresponding to the signal transmitted through the second transmission antenna 121-2 of the signal transmission apparatus in the combined incoming signal vector Y.

The signal detector 315 outputs \hat{x}_{ZF1} to the first IFFT unit 317-1 and \hat{x}_{ZF2} to the second IFFT unit 317-2. The first IFFT unit 317-1 restores a transmission symbol stream \hat{x}₁ by performing IFFT on the received \hat{x}_{ZF1} and outputs the restored transmission symbol stream \hat{x}₁ to the first demodulator 319-1. The second IFFT unit 317-2 restores a transmission symbol stream \hat{x}₂ by performing IFFT on the received \hat{x}_{ZF2} and outputs the restored transmission symbol stream \hat{x}₂ to the second demodulator 319-2.

Then, the first demodulator 319-1 demodulates the signal output from the first IFFT unit 317-1 according to the demodulation scheme corresponding to the modulation scheme used in the modulator 115 and outputs the demodulated signal the parallel-to-serial converter 321. Further, the second demodulator 319-2 demodulates the signal output from the second IFFT unit 317-2 according to the demodulation scheme corresponding to the modulation scheme used in the modulator 115 and outputs the demodulated signal the parallel-to-serial converter 321. Then, the parallel-to-serial converter 321 converts the signals output from the first demodulator 319-1 and the second demodulator 319-2 into a serial signal and outputs the converted serial signal to the decoder 323. The decoder 323 decodes the signal output from the parallel-to-serial converter 321 according to a decoding scheme corresponding to the encoding scheme used by the encoder 111 of the signal transmission apparatus, thereby restoring an information data bit stream. Of course, when the decoder 323 cannot normally restore the information data bit stream, the signal reception apparatus transmits NACK information to the signal transmission apparatus as described above.

As a result, when the signal transmission apparatus transmits the information data bit stream for the k^{th} time, relations as defined by equations (20) and (21) below are established. In equations (20) and (21), “evenK” denotes an even transmission and “oddK” denotes an odd^{th} transmission, considering that K may indicate either an even^{th} transmission or an odd^{th} transmission.

$$C = {C}_{evenK} = ( \begin{matrix}{C}_{0 \_evenK} & 0 \\ 0 & {C}_{0 \_evenK}\end{matrix} ) \qquad ( 20 )$$

In equation (20),

$${C}_{0 \_evenK} ( i , i ) = \frac{K}{2} ( {\sum }_{m = 1}^{M} {\vert {Λ}_{1 m} ( i , i ) \vert}^{2} + {\vert {Λ}_{2 m} ( i , i ) \vert}^{2} ) ,$$

wherein i=1, 2, . . . , N.

$$C = {C}_{oddK} = ( \begin{matrix}{C}_{1 \_oddK} & Ω \\ {Ω}^{H} & {C}_{2 \_oddK}\end{matrix} ) \qquad ( 21 )$$

In equation (21),

$$Ω = {\sum }_{m = 1}^{M} {Λ}_{m 1}^{H} {Λ}_{m 1} , \\ {C}_{1 \_oddK} ( i , i ) = \frac{K + 1}{2} {\sum }_{m = 1}^{M} {\vert {Λ}_{1 m} ( i , i ) \vert}^{2} + \frac{K - 1}{2} {\sum }_{m = 1}^{M} {\vert {Λ}_{2 m} ( i , i ) \vert}^{2}$$

wherein i=1, 2, . . . , N, and

$${C}_{2 \_oddK} ( i , i ) = \frac{K - 1}{2} {\sum }_{m = 1}^{M} {\vert {Λ}_{1 m} ( i , i ) \vert}^{2} + \frac{K + 1}{2} {\sum }_{m = 1}^{M} {\vert {Λ}_{2 m} ( i , i ) \vert}^{2}$$

wherein i=1, 2, . . . , N.

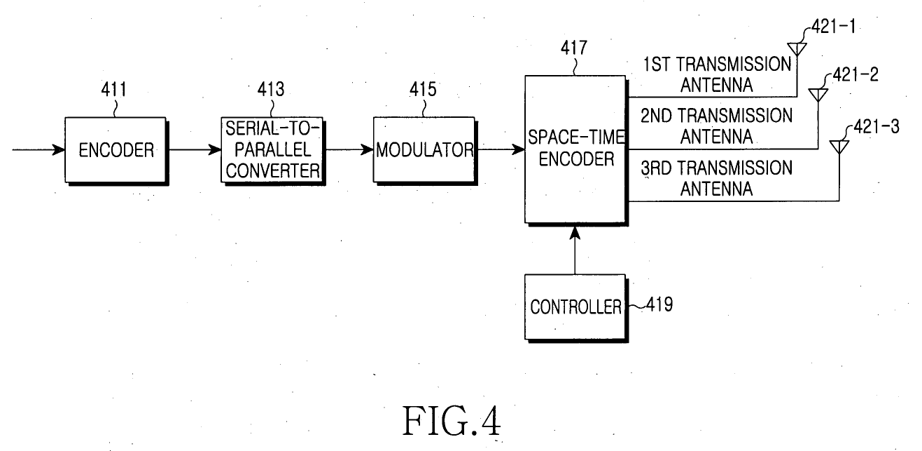

The above description with reference to FIGS. 1 to 3 discusses an operation of signal transmission/reception when a signal transmission apparatus uses two transmission antennas in the MIMO-HARQ communication system. Hereinafter, an operation of signal transmission/reception when a signal transmission apparatus uses three transmission antennas in the MIMO-HARQ communication system will be described with reference to FIGS. 4 to 6.

FIG. 4 is a block diagram of a signal transmission apparatus having three transmission antennas (M_{T}=3) in a MIMO-HARQ communication system according to another embodiment of the present invention.

Referring to FIG. 4, the signal transmission apparatus includes an encoder 411, a serial-to-parallel converter 413, a modulator 415, a space-time encoder 417, a controller 419, a first transmission antenna 421-1, a second transmission antenna 421-2, and a third transmission antenna 421-3.

First, when an information data bit stream to be transmitted is input to the signal transmission apparatus, the information data bit stream is transferred to the encoder 411. It is assumed that the information data bit stream has a length of a, that is, the information data bit stream includes a number of information data bits. Then, the encoder 411 generates a codeword C having a length of n by encoding the information data bit stream according to a predetermined encoding scheme, and outputs the generated codeword C to the serial-to-parallel converter 413. It is assumed that the codeword output from the encoder 411 corresponds to (n, a) CRC code. The serial-to-parallel converter 413 parallel-converts the (n, a) CRC code into three sub-blocks and outputs the converted sub-blocks to the modulator 415. It is assumed that each of the sub-blocks has a length n_{T} of n/3

$$( {n}_{T} = \frac{n}{3} ) .$$

The modulator 415 generates modulation symbol streams by modulating each of the three sub-blocks output from the serial-to-parallel converter 413 according to a predetermined modulation scheme, and outputs the generated modulation symbol streams to the space-time encoder 417. For the modulation, the modulator 415 uses one modulation scheme selected from among a Binary Phase Shift Keying (BPSK) scheme having a constellation C of 2^{b}, a Quadrature Phase Shift Keying (QPSK) scheme, an 8-PSK scheme, and a 16 Quadrature Amplitude Modulation (16-QAM) scheme. Therefore, the modulator 415 modulates each of the sub-blocks having a length of n_{T} into a modulation symbol stream including N number of modulation symbols

$$( N = \frac{{n}_{T}}{b} ) .$$

The modulation symbol stream output from the modulator 415 can be defined by equation (1), wherein i, which denotes a modulation symbol stream index, has a value of 1, 2, or 3 (i=1, 2, 3) because the modulator 415 generates three modulation symbol streams.

The space-time encoder 417 receives the modulation symbol streams output from the modulator 415, space-time encodes the received modulation symbol streams under the control of the controller 419, and outputs the encoded streams to corresponding transmission antennas. Hereinafter, an operation of controlling the space-time encoding of the space-time encoder 417 by the controller 419 will be discussed.

First, the controller 419 controls the operation of the space-time encoder 417 based on the ACK or NACK information which the controller 419 received from a signal reception apparatus, that is, information indicating if there is an error in the information data bit stream transmitted by the signal transmission apparatus in a previous transmission time interval. Of course, when the information data bit stream is initially transmitted, the controller 419 does not take the ACK or NACK information into consideration because there is no received ACK or NACK information from the signal reception apparatus. When the controller 419 receives NACK information from the signal reception apparatus, the controller 419 re-transmits a corresponding information data bit stream.

First, in the case of an odd^{th} transmission of the information data bit stream, under the control of the controller 419, the space-time encoder 417 transmits the modulation symbol streams output from the modulator 415 as they are through corresponding transmission antennas. In the case of odd^{th} transmission of the information data bit stream, the transmission symbol stream output by the space-time encoder 417 to be transmitted through each transmission antenna can be defined by equation (2), wherein j, which denotes a transmission antenna index, has a value of 1, 2, or 3 (j=1, 2, 3) because the signal transmission apparatus uses three transmission antennas.

That is, under the control of the controller 419, in the case of an odd^{th} transmission of the information data bit stream, the space-time encoder 417 transmits x₁^{k}=└s₁^{k}(0),s₁^{k}(1), . . . ,s₁^{k}(N−1)┘ through the first transmission antenna 421-1, x₂^{k}=└s₂^{k}(0),s₃^{k}(1), . . . ,s₃^{k}(N−1)┘ through the second transmission antenna 421-2, and x₃^{k}=└s₃^{k}(0),s₃^{k}(1), . . . ,s₃^{k}(N−1)┘ through the third transmission antenna 421-3. In the case of an odd^{th} transmission of the information data bit stream as described above, it is noted that the transmission symbol stream transmitted through the first transmission antenna 421-1 is identical to the first modulation symbol stream s₁ output from the modulator 415, the transmission symbol stream transmitted through the second transmission antenna 421-2 is identical to the second modulation symbol stream s₂ output from the modulator 415, and the transmission symbol stream transmitted through the third transmission antenna 421-3 is identical to the third modulation symbol stream s₃ output from the modulator 415.

Next, in the case of an even^{th} transmission of the information data bit stream, under the control of the controller 419, the space-time encoder 417 space-time encodes the modulation symbols output from the modulator 415 according to a Space Time Block Coding (STBC) scheme and transmits the encoded modulation symbols through corresponding transmission antennas. It is assumed that the STBC scheme is, for example, the Alamouti space time block coding scheme. In the case of an even^{th} transmission of the information data bit stream, the controller 419 controls the operation of the space-time encoder 417 according to one of the following three transmission schemes.

(1) 1^{st} Transmission Scheme

According to the first transmission scheme, under the control of the controller 419, the space-time encoder 417 transmits x₁^{k+1}=└−s₂^{k*}(0),−s₂^{k*}(N−1), . . . ,−s₂^{k*}(1)┘ through the first transmission antenna 421-1, transmits x₂^{k+1}=└s₁^{k*}(0),s₁^{k*}(N−1), . . . ,s₁^{k*}(1)┘ through the second transmission antenna 421-2, and transmits x₃^{k+1}=[0,0, . . . ,0] through the third transmission antenna 421-3.

(2) 2^{nd} Transmission Scheme

According to the second transmission scheme, under the control of the controller 419, the space-time encoder 417 transmits x₁^{k+1}=└s₃^{k*}(0),s₃^{k*}(N−1), . . . ,−s₁^{k*}(1)┘ through the first transmission antenna 421-1, transmits x₃^{k+1}=[0,0, . . . ,0] through the second transmission antenna 421-2, and transmits x₃^{k+1}=└−s₁^{k*}(0),−s₁^{k*}(N−1), . . . ,s₁^{k*}(1)┘ through the third transmission antenna 421-3.

(3) 3^{rd} Transmission Scheme

According to the third transmission scheme, under the control of the controller 419, the space-time encoder 417 transmits x₁^{k+1}=[0,0, . . . ,0] through the first transmission antenna 421-1, transmits x₂^{k+1}=└−s₃^{k*}(0),−s₃^{k*}(N−1), . . . ,−s₃^{k*}(1)┘ through the second transmission antenna 421-2, and transmits x₃^{k+1}=└s₂^{k*}(0),s₂^{k*}(N−1), . . . ,s₂^{k*}(1)┘ through the third transmission antenna 421-3.

Hereinafter, an operation of selecting one of the three transmission schemes for the space-time encoder 417 by the controller 419 will be described.

First, the controller 419 selects a transmission scheme to be used by the space-time encoder 417 so that the space-time encoder 417 can use a transmission scheme having a minimum symbol error probability. That is, for a transmission scheme to be used by the space-time encoder 417, the controller 419 selects a transmission scheme that has a minimum symbol error probability when it is used by the space-time encoder 417, thereby improving the general performance of the communication system. The symbol error probability can be defined by equation (22) below.

$$P = 1 - {\prod }_{k = 1}^{{M}_{T} N} ( 1 - {P}_{k} ) \qquad ( 22 )$$

In equation (22),

$${P}_{k} = {N}_{e} Q ( \sqrt{{SNR}_{k} \frac{{d}_{min}^{2}}{2}} ) ,$$

wherein dₘᵢₙ denotes a minimum distance for each antenna constellation, and Nₑ denotes an average number of nearest neighbor symbols on the constellation which has the largest influence on the symbol error rate.

Further, in the case of using Nearest Neighbor Union Bound (NNUB), equation (22) can be replaced by equation (23) as defined below.

$$P \leq 1 - {[ 1 - {N}_{e} Q ( \sqrt{{SNR}_{min} \frac{{d}_{min}^{2}}{2}} ) ]}^{{M}_{T} N} \approx {M}_{T} {NN}_{e} Q ( \sqrt{{SNR}_{min} \frac{{d}_{min}^{2}}{2}} ) \qquad ( 23 )$$

In equation (23), SNRₘᵢₙ denotes the minimum SNR from among the SNRs of M_{T}N number of received symbols.

The controller 419 selects the maximum SNR_{p,d[min]}^{(ZF)} for each of the three transmission schemes, and the maximum SNR_{p,d[min]}^{(ZF)} can be defined by equation (24) below.
SNR_{p,d[min]}^{(ZF)}=minₚSNR_{p,d}^{(ZF)} (24)

In equation (24), p=1, . . . , M_{T}N, and d is an index denoting the transmission scheme. Because the space-time encoder 417 can use one of the first to third transmission schemes as described above, d=1, 2, or 3.

After selecting the transmission scheme to be used by 417 as described above, the controller 419 controls the space-time encoding of the space-time encoder 417 in accordance with the selected transmission scheme. However, when the information data bit stream transmitted according to the selected transmission scheme has not been normally restored, that is, when NACK information has been received from the signal reception apparatus, the controller 419 selects one of the remaining transmission schemes except for the initially selected transmission scheme, so as to control the operation of the space-time encoder 417. For example, on an assumption that the first transmission scheme has been used for the second transmission, that is, for the first re-transmission, when NACK information for the second transmission is received from the signal reception apparatus, the controller 419 determines one of the remaining transmission schemes except for the first transmission scheme used for the first re-transmission as the transmission to be newly used for the second re-transmission. Meanwhile, the SNR obtained after execution of the second re-transmission can be defined by equation (25) below.

$${SNR}_{p , d , l}^{( ZF )} = \frac{{P}_{0}}{{{N}_{0} [ {Q}_{( N )}^{- 1} {Ω}_{( 3 ) d , l}^{- 1} ( 3 C + 2 {Ξ}_{d}^{T} {C}^{*} {Ξ}_{d} + 2 {Ξ}_{l}^{T} {C}^{*} {Ξ}_{l} ) {Ω}_{( 3 ) d , l}^{- 1 H} {Q}_{( N )}^{- 1 H} ]}_{pp}} \qquad ( 25 )$$

In equation (25), d is an index indicating the transmission scheme selected for the first re-transmission, l is an index indicating the transmission scheme selected for the second re-transmission, and [ ]ₚₚ refers to the p^{th} row and p^{th} column of a matrix. Further, each of

$${Ξ}_{d}^{T} and {Ξ}_{l}^{T}$$

_{d}^{T} and [symbol] ₗ^{T} corresponds to one of matrixes defined by equation (25-1), and is identified by an index indicating the transmission scheme of the first re-transmission or the second re-transmission.

$$\begin{matrix}{Ξ}_{1} = ( \begin{matrix}0 & - 1 & 0 \\ 1 & 0 & 0 \\ 0 & 0 & 0\end{matrix} ) & {Ξ}_{2} = ( \begin{matrix}0 & 0 & 1 \\ 0 & 0 & 0 \\ - 1 & 0 & 0\end{matrix} ) & {Ξ}_{3} = ( \begin{matrix}0 & 0 & 0 \\ 0 & 0 & - 1 \\ 0 & 1 & 0\end{matrix} )\end{matrix} \qquad ( 25 \text{-} 1 )$$

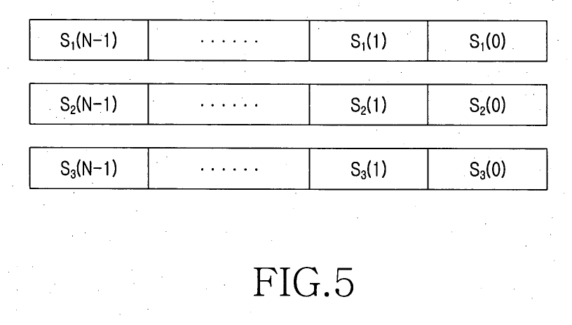

Next, structures of transmission symbol streams transmitted by the signal transmission apparatus of FIG. 4 will be described with reference to FIG. 5.

FIG. 5 schematically illustrates structures of transmission symbol streams transmitted by the signal transmission apparatus of FIG. 4.

The structure shown in FIG. 5 corresponds to a structure of transmission symbol streams in the case of the k^{th} transmission (an odd^{th} transmission) of the information data bit stream.

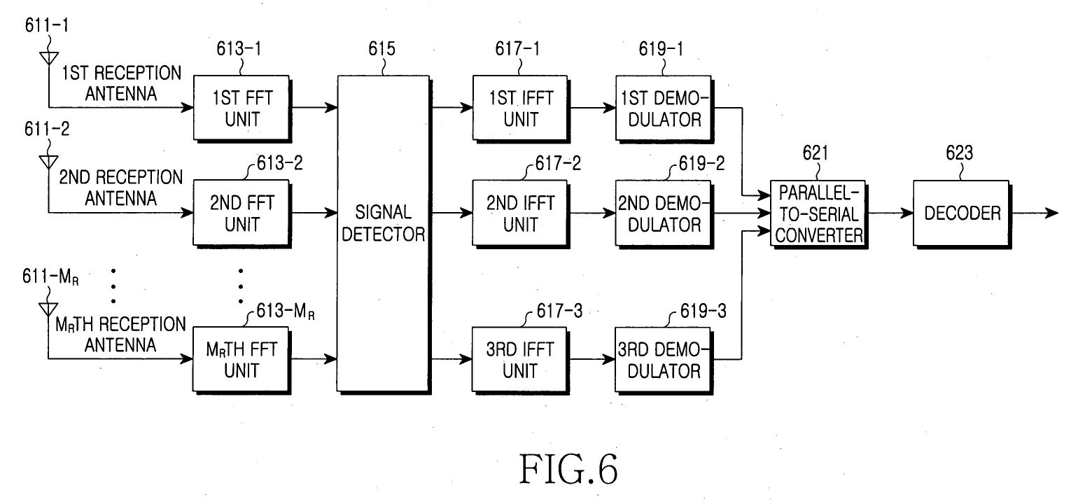

Hereinafter, an internal structure of a signal reception apparatus corresponding to the signal transmission apparatus of FIG. 4 will be described with reference to FIG. 6.

FIG. 6 is a block diagram illustrating an internal structure of a signal reception apparatus corresponding to the signal transmission apparatus of FIG. 4.

Referring to FIG. 6, the signal reception apparatus includes a plurality of reception antennas, for example, an M_{R} number of antennas including a first reception antenna 611-1 to an M_{R}^{th} reception antenna 611-M_{R}, an M_{R} number of Fast Fourier Transform (FFT) units including a first FFT unit 613-1 to an M_{R}^{th} FFT unit 613-M_{R}, a signal detector 615, three Inverse Fast Fourier Transform (IFFT) units including a first IFFT unit 617-1 to a third IFFT unit 617-3, three demodulators including a first demodulator 619-1 to a third demodulator 619-3, a parallel-to-serial converter 621, and a decoder 623.

First, when the information data bit stream has been transmitted for an odd^{th} time, that is, for the k^{th} time by the signal transmission apparatus of FIG. 4, the signals radiated from the three transmission antennas of the signal transmission apparatus are received by each of the M_{R} number of antennas, and the M_{R} number of antennas then transfer the received signals to corresponding FFT units, respectively. Specifically, the first reception antenna 611-1 outputs the received signal to the first FFT unit 613-1, the second reception antenna 611-2 outputs the received signal to the second FFT unit 613-2, and the M_{R}^{th} reception antenna 611-M_{R} outputs the received signal to the M_{R}^{th} FFT unit 613-M_{R}. Each of the first FFT unit 613-1 to the M_{R}^{th} FFT unit 613-M_{R} performs an operation on the input signal and outputs the FFTed signal to the signal detector 615.

The signal detector 615 receives and linearly combines the signals output from the first FFT unit 613-1 to the M_{R}^{th} FFT unit 613-M_{R}, thereby generating an incoming signal vector. When it is assumed that the entire transmission power available in the signal transmission apparatus has been normalized to P₀, the first incoming signal vector Y⁽¹⁾ corresponding to the first information data bit stream can be defined by equation (26) below.

$${Y}^{( 1 )} = \sqrt{\frac{{P}_{0}}{3}} Λ {X}^{( 1 )} + {W}^{( 1 )} \qquad ( 26 )$$

In equation (26),

$$Λ = [ {Λ}_{1} {Λ}_{2} {Λ}_{3} ] = {( \begin{matrix}{Λ}_{11} & {Λ}_{12} & {Λ}_{13} \\ {Λ}_{21} & {Λ}_{22} & {Λ}_{23} \\ ⋮ & ⋮ & ⋮ \\ {Λ}_{{M}_{R} 1} & {Λ}_{{M}_{R} 2} & {Λ}_{{M}_{R} 3}\end{matrix} )}_{{NM}_{R} \times {NM}_{T}} , \\ {X}^{( 1 )} = ( \begin{matrix}{X}_{1}^{( 1 )} \\ {X}_{2}^{( 2 )} \\ {X}_{3}^{( 3 )}\end{matrix} ) , \\ and$$

$${W}^{( 1 )} = {( \begin{matrix}{W}_{1}^{( 1 )} \\ {W}_{2}^{( 2 )} \\ ⋮ \\ {W}_{{M}_{R}}^{( 1 )}\end{matrix} )}_{{M}_{R} \times 1} .$$

Meanwhile, the signal detector 615 receives the signals output from the first FFT unit 613-1 to the M_{R}^{th} FFT unit 613-M_{R} and detects the signals according to a predetermined signal detection scheme, for example, according to the ZF scheme or the MMSE scheme.

First, when the signal detector 615 detects a signal according to the MMSE scheme, the detected signal can be defined by equation (27) below.

$${\hat{X}}_{mmse}^{( k )} = {( {Λ}^{H} Λ + \frac{1}{SNR} {I}_{3 N} )}^{- 1} \sqrt{\frac{3}{{P}_{0}}} {Λ}^{H} {Y}^{( k )} \qquad ( 27 )$$

In equation (27), \hat{X}ₘₘₛₑ^{(k)} includes \hat{X}ₘₘₛₑ₁^{(k)}, which denotes a detected signal corresponding to the signal transmitted through the first transmission antenna 421-1 of the signal transmission apparatus, \hat{X}ₘₘₛₑ₂^{(k)}, which denotes a detected signal corresponding to the signal transmitted through the second transmission antenna 421-2 of the signal transmission apparatus, and \hat{X}ₘₘₛₑ₃^{(k)}, which denotes a detected signal corresponding to the signal transmitted through the third transmission antenna 421-3 of the signal transmission apparatus.

Second, an operation for detecting a signal according to a ZF scheme by the signal detector 615 will be discussed.

A signal detected according to a ZF scheme by the signal detector 615 can be defined by equation (28) below.

$${\hat{x}}_{ZF}^{( 1 )} = {( {Λ}^{H} Λ )}^{- 1} ( \sqrt{\frac{3}{{P}_{0}}} {Λ}^{H} {Y}^{( 1 )} ) \qquad ( 28 )$$

In equation (28), \hat{x}_{ZF}⁽¹⁾ includes \hat{x}_{ZF1}⁽¹⁾, which denotes a detection signal corresponding to the signal transmitted through the first transmission antenna 421-1 of the signal transmission apparatus, \hat{x}_{ZF2}⁽²⁾, which denotes a detection signal corresponding to the signal transmitted through the second transmission antenna 421-2 of the signal transmission apparatus, and \hat{x}_{ZF2}⁽³⁾, which denotes a detection signal corresponding to the signal transmitted through the third transmission antenna 421-3 of the signal transmission apparatus.

An incoming signal vector received for the transmission scheme d selected after the first re-transmission as described above with reference to FIG. 4 can be defined by equation (29) below.

$${Y}_{d}^{{( 2 )}^{*}} = \sqrt{\frac{{P}_{0}}{2}} {Λ}^{*} {Ξ}_{d} {X}^{( 1 )} + {W}^{{( 2 )}^{*}} \qquad ( 29 )$$

Therefore, a sum of the incoming signal vectors according to the first transmission and the second transmission can be defined by equation (30) below.

$$\begin{matrix}{\sum }_{( 2 ) d} = \sqrt{\frac{2}{{P}_{0}}} {( {Λ}^{*} {Ξ}_{d} )}^{H} {Y}_{d}^{{( 2 )}^{*}} + \sqrt{\frac{3}{{P}_{0}}} {Λ}^{H} {Y}^{( 1 )} \\ = ( C + {Ξ}_{d}^{T} {C}^{*} {Ξ}_{d} ) {X}^{( 1 )} + \sqrt{\frac{3}{{P}_{0}}} {Λ}^{H} {Q}^{( 1 )} + \sqrt{\frac{2}{{P}_{0}}} {Ξ}_{d}^{T} {Λ}^{T} {W}^{{( 2 )}^{*}} \\ = {Ω}_{( 2 ) d} {X}^{91 )} + {Ψ}_{( 2 ) d}\end{matrix} \qquad ( 30 )$$

In equation (30), Ω_{(2)d}+(C+_{d}^{T}C*ᵢ)

$${Ψ}_{( 2 ) d} = \sqrt{\frac{3}{{P}_{0}}} {Λ}^{H} {W}^{( 1 )} + \sqrt{\frac{2}{{P}_{0}}} {Ξ}_{d}^{T} {Λ}^{T} {W}^{{( 2 )}^{*}} ,$$

and C=Λ^{H}Λ.

Meanwhile, a signal detected according to a ZF scheme for the second transmission by the signal detector 615 can be defined by equation (31) below.
\hat{x}_{ZF}⁽²⁾=X⁽¹⁾+χ_{(2)d}⁻¹Ψ_{(2)d} (31)

Therefore, the SNR can be defined by equation (32) below.

$${SNR}_{p , d}^{( ZF )} = \frac{{P}_{0}}{{{N}_{0} [ {Q}_{( N )}^{- 1} {Ω}_{( 2 ) d}^{- 1} ( 3 C + 2 {Ξ}_{d}^{T} {C}^{*} {Ξ}_{d} ) {Ω}_{( 2 ) d}^{- 1 H} {Q}_{( N )}^{- 1 H} ]}_{pp}} \qquad ( 32 )$$

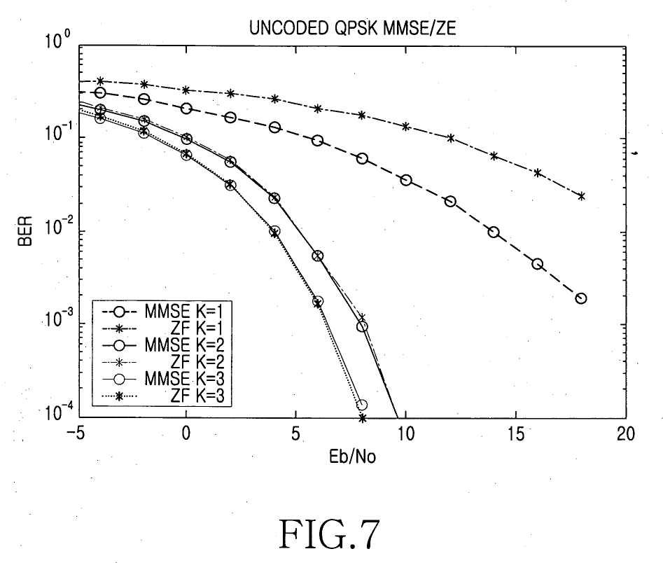

Next, a performance of a MIMO-HARQ communication system according to an embodiment of the present invention, in which the signal transmission apparatus uses two transmission antennas and the signal reception apparatus uses two reception antennas, will be described with reference to FIGS. 7 to 11. It should be noted that the performance graphs shown FIGS. 7 to 11 have been obtained based on the following assumptions:

(1) the number of symbols for each sub-block: 512;

(2) the length of Cyclic Prefix: 32;

(3) FFT size: 512;

(4) modulation scheme: QPSK scheme; and

(5) channel model:

1) multi-path model: Rayleigh fading channel having an exponentially decaying power profile; and

2) the channel is defined by Root Mean Square (RMS) delay spread of a tap weight and has a uniform but large dispersion during K times of information data transmission.

Further, the impulse response of the channel includes complex samples having a Rayleigh scattering size, which have a random uniform scattering phase and an exponentially decaying average power, as defined by equation (33) below.

$${h}_{k} = N ( 0 , \frac{1}{2} {σ}_{k}^{2} ) + j N ( 0 , \frac{1}{2} {σ}_{k}^{2} ) \qquad ( 33 )$$

In equation (33),

$${σ}_{k}^{2} = {σ}_{0}^{2} {ⅇ}^{- \frac{k}{τ rms}} , \\ wherein$$

$${σ}_{0}^{2} = 1 - {ⅇ}^{- \frac{k}{{τ}_{rms}}} ,$$

wherein τᵣₘₛ denotes the delay spread of the channel normalized to the sampling rate. Further, the maximum number L of taps can be dynamically set in accordance with the power difference between the last tap and the first tap, with a dynamic range below 20 dB, that is, L≧τᵣₘₛ. FIGS. 7 to 11 are based on an assumption that τᵣₘₛ=1 and L=5.

FIG. 7 is a graph showing a Bit Error Rate (BER) performance according to the number of times by which an information data bit stream is transmitted when a signal transmission apparatus uses two transmission antennas and a signal reception apparatus uses two reception antennas in a MIMO-HARQ communication system according to an embodiment of the present invention.

The BER performance graph shown in FIG. 7 illustrates a BER according to the number of times K by which an information data bit stream is transmitted when the MMSE scheme or ZF scheme is used as a signal detection scheme. As noted from FIG. 7, the BER performance improves as K increases.

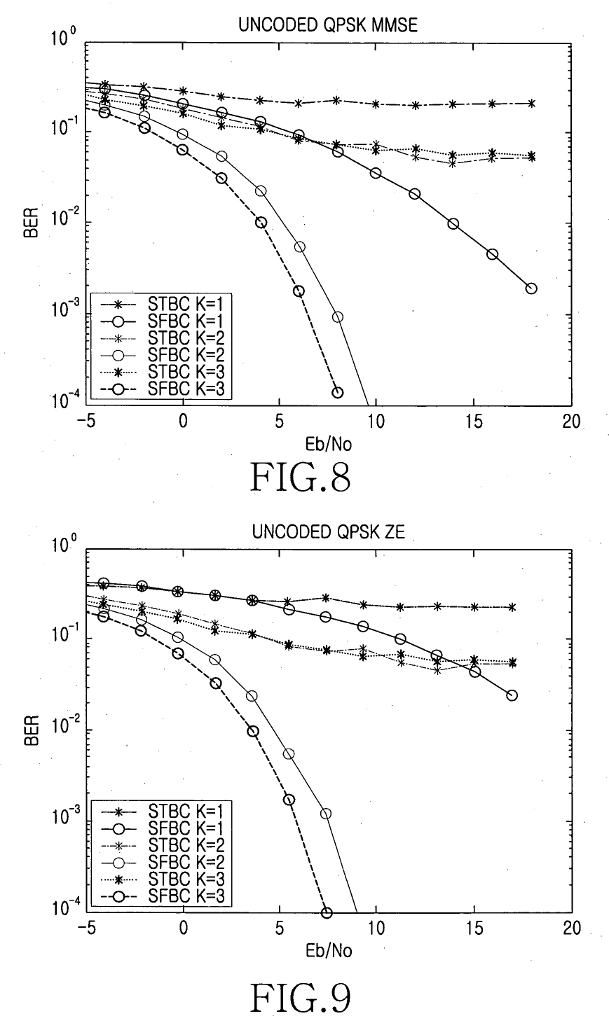

FIG. 8 is a graph for comparison between a performance of a MIMO-HARQ communication system according to an embodiment of the present invention, which includes a signal transmission apparatus using two transmission antennas and a signal reception apparatus using two reception antennas, uses an MMSE scheme for signal detection, and is in a frequency selective channel environment, and a performance of a typical MIMO communication system, which uses only the STBC scheme.

As noted from FIG. 8, the performance of a MIMO-HARQ communication system according to an embodiment of the present invention is better than the performance of a typical MIMO communication system using only the STBC scheme. In conclusion, it can be said that a MIMO-HARQ scheme according to an embodiment of the present invention is a Space Frequency Block Coding (SFBC) scheme which reflects both the space and the frequency. Therefore, the lines marked by SFBC in FIG. 8 show the performance in the case of using a MIMO-HARQ communication system according to an embodiment of the present invention.

FIG. 9 is a graph for comparison between a performance of a MIMO-HARQ communication system according to an embodiment of the present invention, which includes a signal transmission apparatus using two transmission antennas and a signal reception apparatus using two reception antennas, uses a ZF scheme for signal detection, and is in a frequency selective channel environment, and a performance of a typical MIMO communication system, which uses only the STBC scheme.

As noted from FIG. 9, the performance of a MIMO-HARQ communication system according to an embodiment of the present invention is better than the performance of a typical MIMO communication system using only the STBC scheme. The lines marked by SFBC in FIG. 9 show the performance in the case of using a MIMO-HARQ communication system according to an embodiment of the present invention.

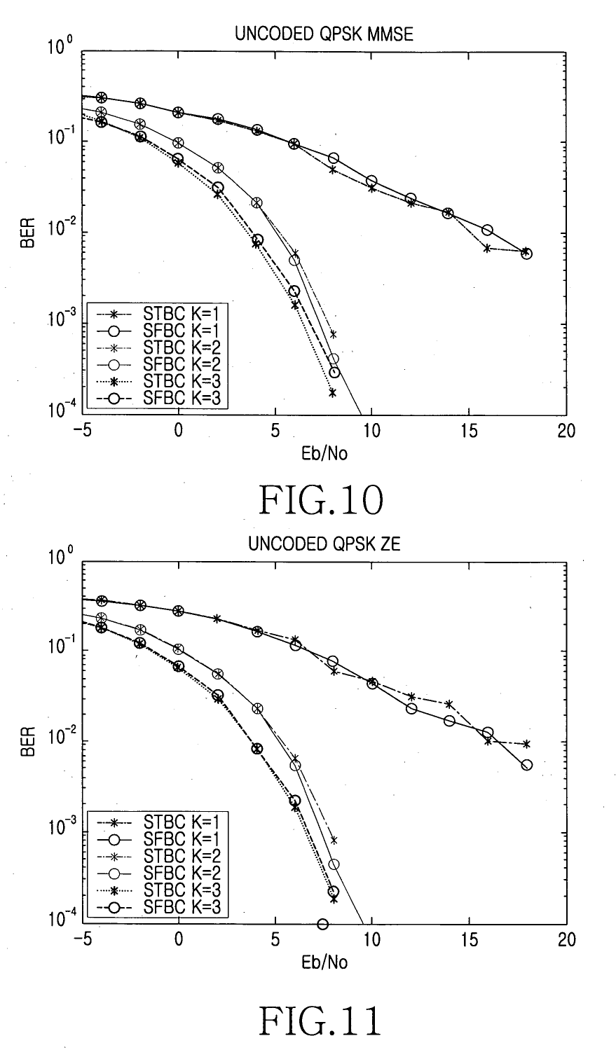

FIG. 10 is a graph for comparison between a performance of a MIMO-HARQ communication system according to an embodiment of the present invention, which includes a signal transmission apparatus using two transmission antennas and a signal reception apparatus using two reception antennas, uses an MMSE scheme for signal detection, and is in a flat fading channel environment, and a performance of a typical MIMO communication system, which uses only the STBC scheme.

As noted from FIG. 10, the performance of a MIMO-HARQ communication system according to an embodiment of the present invention is better than the performance of a typical MIMO communication system using only the STBC scheme. The lines marked by SFBC in FIG. 10 show the performance in the case of using a MIMO-HARQ communication system according to an embodiment of the present invention.

FIG. 11 is a graph for comparison between a performance of a MIMO-HARQ communication system according to an embodiment of the present invention, which includes a signal transmission apparatus using two transmission antennas and a signal reception apparatus using two reception antennas, uses a ZF scheme for signal detection, and is in a flat fading channel environment, and a performance of a typical MIMO communication system, which uses only the STBC scheme.

As noted from FIG. 11, the performance of a MIMO-HARQ communication system according to an embodiment of the present invention is better than the performance of a typical MIMO communication system using only the STBC scheme. The lines marked by SFBC in FIG. 1 show the performance in the case of using a MIMO-HARQ communication system according to an embodiment of the present invention.

According to the present invention as described above, it is possible to transmit/receive a signal by using an HARQ scheme capable of considering the frequency selective fading channel environment in a MIMO communication system. That is, the present invention enables signal transmission/reception according to the MIMO-HARQ scheme in consideration of actual channel environments of the communication system, thereby improving the performance of the entire communication system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for transmitting a signal in a communication system, the apparatus comprising:
M_{T} number of transmission antennas;
a space-time encoder for generating M_{T} number of transmission symbol streams by space-time encoding M_{T} number of modulation symbol streams in accordance with a space-time encoding scheme determined by a predetermined control, and transmitting each of the M_{T} transmission symbol streams through a corresponding transmission antenna from among the M_{T} transmission antennas; and
a controller for determining the space-time encoding scheme based on an iteration number of transmission, which indicates the number of times by which an information data bit stream corresponding to the M_{T} modulation symbol streams has been transmitted.

2. The apparatus as claimed in claim 1, wherein, when the iteration number of transmission corresponds to an odd number (k=1, 3, 5, . . . ), which implies an odd^{th} transmission of the information data bit stream, the controller determines the space-time encoding scheme such that the M_{T} transmission symbol streams are generated from the M_{T} modulation symbol streams without change.

3. The apparatus as claimed in claim 1, wherein, when the iteration number of transmission corresponds to an even number (k+i=2, 4, 6, . . . ), which implies an even^{th} transmission of the information data bit stream, the controller determines a space-time block coding scheme as the space-time encoding scheme, so that the M_{T} transmission symbol streams are generated by space-time encoding the transmission symbol streams having been transmitted in the odd^{th} transmission (k=1, 3, 5, . . . ) of the information data bit stream according to the space-time block coding scheme.

4. The apparatus as claimed in claim 3, wherein the space-time block coding scheme includes an Alamouti space time block coding scheme.

5. The apparatus as claimed in claim 1, wherein, when the modulation symbol streams include N number of modulation symbols and the iteration number of transmission corresponds to an odd number (k=1, 3, 5, . . . ), the controller determines the space-time encoding scheme such that the space-time encoder generates the transmission symbol streams defined by
xⱼ^{k}=[sⱼ^{k}(0),sⱼ^{k}(1), . . . ,sⱼ^{k}(N−1)],
wherein j denotes a transmission antenna index, which has a value of 1 or 2 (M_{T}=j=1, 2)

6. The apparatus as claimed in claim 5, wherein, when the modulation symbol streams include N number of modulation symbols and M_{T}=2, the controller determines the space-time encoding scheme, by which the space-time encoder generates x₁^{k}=└s₁^{k}(0),s₁^{k}(1), . . . ,s₁^{k}(N−1)┘ for the transmission symbol streams to be transmitted through the first transmission antenna and generates x₂^{k}=└s₂^{k}(0),s₂^{k}(1), . . . ,s₂^{k}(N−1)┘ for the transmission symbol streams to be transmitted through the second transmission antenna.

7. The apparatus as claimed in claim 3, wherein, when the modulation symbol streams include N number of modulation symbols, M_{T}=2, and the iteration number of transmission corresponds to an even number (k+1=2, 4, 6, . . . ), which implies an even^{th} transmission of the information data bit stream, the controller determines a space-time block coding scheme as the space-time encoding scheme, so that the two transmission symbol streams are generated by space-time encoding the transmission symbol streams having been transmitted in the odd^{th} transmission (k=1, 3, 5, . . . ) of the information data bit stream according to the space-time block coding scheme, wherein:
the transmission symbol streams having been transmitted in the odd^{th} transmission of the information data bit stream comprises transmission symbol streams transmitted through the first transmission antenna, defined by x₁^{k}=└s₁^{k}(0),s₁^{k}(1), . . . ,s₁^{k}(N−1)┘, and transmission symbol streams transmitted through the second transmission antenna, defined by x₂^{k}=└s₂^{k}(0),s₂^{k}(1), . . . ,s₂^{k}(N−1)┘; and
the transmission symbol streams to be transmitted in the even^{th} transmission of the information data bit stream comprises transmission symbol streams to be transmitted through the first transmission antenna, defined by x₁^{k+1}=└−s₂^{k*}(0),−s₂^{k*}(N−1), . . . ,−s₂^{k*}(1)┘, and transmission symbol streams to be transmitted through the second transmission antenna, defined by x₂^{k+1}=└s₁^{k*}(0),s₁^{k*}(N−1), . . . ,s₁^{k*}(1)┘.

8. The apparatus as claimed in claim 5, wherein, when the modulation symbol streams include N number of modulation symbols and M_{T}=3, the controller determines the space-time encoding scheme, by which the space-time encoder generates x₁^{k}=└s₁^{k}(0),s₁^{k}(1), . . . ,s₁^{k}(N−1)┘ for the transmission symbol streams to be transmitted through the first transmission antenna, generates x₂^{k}=└s₂^{k}(0),s₂^{k}(1), . . . ,s₂^{k}(N−1)┘ for the transmission symbol streams to be transmitted through the second transmission antenna, and generates x₃^{k}=└s₃^{k}(0),s₃^{k}(1), . . . ,s₃^{k}(N−1)┘ for the transmission symbol streams to be transmitted through the third transmission antenna.

9. The apparatus as claimed in claim 3, wherein, when the modulation symbol streams include N number of modulation symbols, M_{T}=3, and the iteration number of transmission corresponds to an even number (k+1=2, 4, 6, . . . ), which implies an even^{th} transmission of the information data bit stream, the controller determines a space-time block coding scheme as the space-time encoding scheme, so that the three transmission symbol streams are generated by space-time encoding the transmission symbol streams having been transmitted in the odd^{th} transmission (k=1, 3, 5, . . . ) of the information data bit stream according to the space-time block coding scheme, wherein:
the transmission symbol streams having been transmitted in the odd^{th} transmission of the information data bit stream comprises transmission symbol streams transmitted through the first transmission antenna, defined by x₁^{k}=└s₁^{k}(0),s₁^{k}(1), . . . ,s₁^{k}(N−1)┘, transmission symbol streams transmitted through the second transmission antenna, defined by x₂^{k}=└s₂^{k}(0),s₂^{k}(1), . . . ,s₂^{k}(N−1)┘, and transmission symbol streams transmitted through the third transmission antenna, defined by x₃^{k}=└s₂^{k}(0),s₃^{k}(1), . . . ,s₃^{k}(N−1)┘; and
the transmission symbol streams to be transmitted in the even^{th} transmission of the information data bit stream comprises transmission symbol streams to be transmitted through the first transmission antenna, defined by x₁^{k+1}=└−s₂^{k*}(0),−s₂^{k*}(N−1), . . . ,−s₂^{k*}(1)┘, transmission symbol streams to be transmitted through the second transmission antenna, defined by x₂^{k+1}=└s₁^{k*}(0),s₁^{k*}(N−1), . . . ,s₁^{k*}(1)┘, and transmission symbol streams to be transmitted through the third transmission antenna, defined by x₃^{k+1}=[0,0, . . . ,0].

10. The apparatus as claimed in claim 3, wherein, when the modulation symbol streams include N number of modulation symbols, M_{T}=3, and the iteration number of transmission corresponds to an even number (k+1=2, 4, 6, . . . ), which implies an even^{th} transmission of the information data bit stream, the controller determines a space-time block coding scheme as the space-time encoding scheme, so that the three transmission symbol streams are generated by space-time encoding the transmission symbol streams having been transmitted in the odd^{th} transmission (k=1, 3, 5, . . . ) of the information data bit stream according to the space-time block coding scheme, wherein:
the transmission symbol streams having been transmitted in the odd^{th} transmission of the information data bit stream comprises transmission symbol streams transmitted through the first transmission antenna, defined by x₁^{k}=└s₁^{k}(0),s₁^{k}(1), . . . ,s₁^{k}(N−1)┘, transmission symbol streams transmitted through the second transmission antenna, defined by x₂^{k}=└s₂^{k}(0),s₂^{k}(1), . . . ,s₂^{k}(N−1)┘, and transmission symbol streams transmitted through the third transmission antenna, defined by x₃^{k}=└s₃^{k}(0),s₃^{k}(1),s₃^{k}(N−1)┘; and
the transmission symbol streams to be transmitted in the event^{th} transmission of the information data bit stream comprises transmission symbol streams to be transmitted through the first transmission antenna, defined by x₁^{k+1}=└s₃^{k*}(0),s₃^{k*}(N−1), . . . ,s₃^{k*}(1)┘, transmission symbol streams to be transmitted through the second transmission antenna, defined by x₂^{k+1}=[0,0, . . . ,0], and transmission symbol streams to be transmitted through the third transmission antenna, defined by x₃^{k+1}=└−s₁^{k*}(0),−s₁^{k*}(N−1), . . . ,−s₁^{k*}(1)┘.

11. The apparatus as claimed in claim 3, wherein, when the modulation symbol streams include N number of modulation symbols, M_{T}=3, and the iteration number of transmission corresponds to an even number (k+1=2, 4, 6, . . . ), which implies an even^{th} transmission of the information data bit stream, the controller determines a space-time block coding scheme as the space-time encoding scheme, so that the three transmission symbol streams are generated by space-time encoding the transmission symbol streams having been transmitted in the odd^{th} transmission (k=1, 3, 5, . . . ) of the information data bit stream according to the space-time block coding scheme, wherein:
the transmission symbol streams having been transmitted in the odd^{th} transmission of the information data bit stream comprises transmission symbol streams transmitted through the first transmission antenna, defined by x₁^{k}=└s₁^{k}(0),s₁^{k}(1), . . . ,s₁^{k}(N−1)┘, transmission symbol streams transmitted through the second transmission antenna, defined by x₂^{k}=└s₂^{k}(0),s₂^{k}(1), . . . ,s₂^{k}(N−1)┘, and transmission symbol streams transmitted through the third transmission antenna, defined by x₃^{k}=└s₃^{k}(0),s₃^{k}(1), . . . ,s₃^{k}(N−1)┘; and
the transmission symbol streams to be transmitted in the even^{th} transmission of the information data bit stream comprises transmission symbol streams to be transmitted through the first transmission antenna, defined by x₁^{k+1}=[0,0, . . . ,0], transmission symbol streams to be transmitted through the second transmission antenna, defined by x₂^{k+1}=└−s₃^{k*}(0),−s₃^{k*}(N−1), . . . ,−s₃^{k*}(1)┘, and transmission symbol streams to be transmitted through the third transmission antenna, defined by x₃^{k+1}=└s₂^{k*}(0),s₂^{k*}(N−1), . . . ,s₂^{k*}(1)┘.

12. An apparatus for receiving a signal in a communication system, the apparatus comprising:
M_{R} number of reception antennas;
M_{R} number of Fast Fourier Transform (FFT) units connected to the reception antennas, so as to receive signals transmitted through M_{T} number of transmission antennas of a signal transmission apparatus corresponding to the apparatus for receiving a signal, and to perform FFT on the received signals;
a signal detector for generating an incoming signal vector by linearly combining signals output from the M_{R} FFT units, detecting signals from the incoming signal vector according to a predetermined signal detection scheme, and separately outputting M_{T} number of detected signals in accordance with the M_{T} transmission antennas of the signal transmission apparatus;
M_{T} number of Inverse Fast Fourier Transform (IFFT) units for performing IFFT on the signals output from the signal detector; and
M_{T} number of demodulators for demodulating signals output from the IFFT units according to a demodulation scheme corresponding to a modulation scheme used in the signal transmission apparatus.

13. The apparatus as claimed in claim 12, further comprising:
a parallel-to-serial converter for converting signals output from the M_{T} demodulators to a serial signal;
a decoder for decoding a signal output from the parallel-to-serial converter according to a decoding scheme corresponding to a coding scheme used in the signal transmission apparatus.

14. The apparatus as claimed in claim 13, further comprising a transmitter, which transmits NACK information to the signal transmission apparatus when a result of decoding by the decoder shows that there is an error in the information data bit stream transmitted from the signal transmission apparatus, wherein the NACK information indicates that there is an error in the information data bit stream.

15. The apparatus as claimed in claim 14, wherein, when there is a previously detected signal for the same information data stream, the signal detector combines the previously detected signal and a currently detected signal and outputs a combined signal.

16. The apparatus as claimed in claim 12, wherein the signal detection scheme includes a Minimum Mean Square Error (MMSE) scheme and a Zero Forcing (ZF) scheme.

17. A method for transmitting a signal by a signal transmission apparatus in a communication system, the method comprising the steps of:
(1) generating M_{T} number of transmission symbol streams by space-time encoding M_{T} number of modulation symbol streams in accordance with a space-time encoding scheme determined by a predetermined control, and transmitting each of the M_{T} transmission symbol streams through a corresponding transmission antenna from among the M_{T} transmission antennas; and
(2) determining the space-time encoding scheme based on an iteration number of transmission, which indicates the number of times by which an information data bit stream corresponding to the M_{T} modulation symbol streams has been transmitted.

18. The method as claimed in claim 17, wherein, in step (2), when the iteration number of transmission corresponds to an odd number (k=1, 3, 5, . . . ), which implies an odd^{th} transmission of the information data bit stream, the space-time encoding scheme is determined such that the M_{T} transmission symbol streams are generated from the M_{T} modulation symbol streams without change.

19. The method as claimed in claim 17, wherein, in step (2), when the iteration number of transmission corresponds to an even number (k+1=2, 4, 6, . . . ), which implies an even^{th} transmission of the information data bit stream, a space-time block coding scheme is determined as the space-time encoding scheme, so that the M_{T} transmission symbol streams are generated by space-time encoding the transmission symbol streams having been transmitted in the odd^{th} transmission (k=1, 3, 5, . . . ) of the information data bit stream according to the space-time block coding scheme.

20. The method as claimed in claim 19, wherein the space-time block coding scheme includes an Alamouti space time block coding scheme.

21. The method as claimed in claim 17, wherein, in step (2), when the modulation symbol streams include N number of modulation symbols and the iteration number of transmission corresponds to an odd number (k=1, 3, 5, . . . ), the space-time encoding scheme is determined such that the generated transmission symbol streams are defined by
xⱼ^{k}=[sⱼ^{k}(0),sⱼ^{k}(1), . . . ,sⱼ^{k}(N−1)],
wherein j denotes a transmission antenna index, which has a value of 1 or 2 (M_{T}=j=1, 2)

22. The method as claimed in claim 21, wherein, in step (2), when the modulation symbol streams include N number of modulation symbols and M_{T}=2, the space-time encoding scheme is determined such that the transmission symbol streams to be transmitted through the first transmission antenna are defined by x₁^{k}=└s₁^{k}(0),s₁^{k}(1), . . . ,s₁^{k}(N−1)┘ and the transmission symbol streams to be transmitted through the second transmission antenna are defined by x₂^{k}=└s₂^{k}(0),s₂^{k}(1), . . . ,s₂^{k}(N−1)┘.

23. The method as claimed in claim 19, wherein, in step (2), when the modulation symbol streams include N number of modulation symbols, M_{T}=2, and the iteration number of transmission corresponds to an even number (k+1=2, 4, 6, . . . ), which implies an even^{th} transmission of the information data bit stream, a space-time block coding scheme is determined as the space-time encoding scheme, so that the two transmission symbol streams are generated by space-time encoding the transmission symbol streams having been transmitted in the odd^{th} transmission (k=1, 3, 5, . . . ) of the information data bit stream according to the space-time block coding scheme, wherein:
the transmission symbol streams having been transmitted in the odd^{th} transmission of the information data bit stream comprises transmission symbol streams transmitted through the first transmission antenna, defined by x₁^{k}=└s₁^{k}(0),s₁^{k}(1), . . . ,s₁^{k}(N−1)┘, and transmission symbol streams transmitted through the second transmission antenna, defined by x₂^{k}=└s₂^{k}(0),s₂^{k}(1), . . . ,s₂^{k}(N−1)┘; and
the transmission symbol streams to be transmitted in the even^{th} transmission of the information data bit stream comprises transmission symbol streams to be transmitted through the first transmission antenna, defined by x₁^{k+1}=└−s₂^{k*}(0),−s₂^{k*}(N−1), . . . ,−s₂^{k*}(1)┘, and transmission symbol streams to be transmitted through the second transmission antenna, defined by x₂^{k+1}=└s₁^{k*}(0), s₁^{k*}(N−1), . . . ,s₁^{k*}(1)┘.

24. The method as claimed in claim 21, wherein, in step (2), when the modulation symbol streams include N number of modulation symbols and M_{T}=3, the space-time encoding scheme is determined such that the transmission symbol streams to be transmitted through the first transmission antenna are defined by x₁^{k}=s₁^{k}(0),s₁^{k}(1), . . . ,s₁^{k}(N−1)┘, the transmission symbol streams to be transmitted through the second transmission antenna are defined by x₂^{k}=└s₂^{k}(0),s₂^{k}(1), . . . , s₂^{k}(N−1)┘, and the transmission symbol streams to be transmitted through the third transmission antenna are defined by x₃^{k}=└s₃^{k}(0),s₃^{k}(1), . . . ,s₃^{k}(N−1)┘.

25. The method as claimed in claim 19, wherein, in step (2), when the modulation symbol streams include N number of modulation symbols, M_{T}=3, and the iteration number of transmission corresponds to an even number (k+1=2, 4, 6, . . . ), which implies an even^{th} transmission of the information data bit stream, a space-time block coding scheme is determined as the space-time encoding scheme, so that the three transmission symbol streams are generated by space-time encoding the transmission symbol streams having been transmitted in the odd^{th} transmission (k=1, 3, 5, . . . ) of the information data bit stream according to the space-time block coding scheme, wherein:
the transmission symbol streams having been transmitted in the odd^{th} transmission of the information data bit stream comprises transmission symbol streams transmitted through the first transmission antenna, defined by x₁^{k}=└s₁^{k}(0),s₁^{k}(1), . . . ,s₁^{k}(N−1)┘, transmission symbol streams transmitted through the second transmission antenna, defined by x₂^{k}=└s₂^{k}(0),s₂^{k}(1), . . . ,s₂^{k}(N−1)┘, and transmission symbol streams transmitted through the third transmission antenna, defined by x₃^{k}=└s₃^{k}(0), . . . ,s₃^{k}(N−1)┘; and
the transmission symbol streams to be transmitted in the even^{th} transmission of the information data bit stream comprises transmission symbol streams to be transmitted through the first transmission antenna, defined by x₁^{k+1}=└−s₂^{k*}(0),−s₂^{k*}(N−1), . . . ,s₂^{k*}(1)┘, transmission symbol streams to be transmitted through the second transmission antenna, defined by x₂^{k+1}=└s₁^{k*}(1),s₁^{k*}(N−1), . . . ,s₁^{k*}(1)┘, and transmission symbol streams to be transmitted through the third transmission antenna, defined by x₃^{k+1}=[0,0, . . . ,0].

26. The method as claimed in claim 19, wherein, in step (2), when the modulation symbol streams include N number of modulation symbols, M_{T}=3, and the iteration number of transmission corresponds to an even number (k+1=2, 4, 6, . . . ), which implies an even^{th} transmission of the information data bit stream, a space-time block coding scheme is determined as the space-time encoding scheme, so that the three transmission symbol streams are generated by space-time encoding the transmission symbol streams having been transmitted in the odd^{th} transmission (k=1, 3, 5, . . . ) of the information data bit stream according to the space-time block coding scheme, wherein:
the transmission symbol streams having been transmitted in the odd^{th} transmission of the information data bit stream comprises transmission symbol streams transmitted through the first transmission antenna, defined by x₁^{k}=┌s₁^{k}(0),s₁^{k}(1), . . . ,s₁^{k}(N−1)┘, transmission symbol streams transmitted through the second transmission antenna, defined by x₂^{k}=└s₂^{k}(0),s₂^{k}(1), . . . ,s₂^{k}(N−1)┘, and transmission symbol streams transmitted through the third transmission antenna, defined by x₃^{k}=└s₃^{k}(0),s₃^{k}(1), . . . ,s₃^{k}(N−1)┘; and
the transmission symbol streams to be transmitted in the even^{th} transmission of the information data bit stream comprises transmission symbol streams to be transmitted through the first transmission antenna, defined by x₁^{k+1}=└s₃^{k*}(0),s₃^{k*}(N−1), . . . ,s₃^{k*}(1)┘, transmission symbol streams to be transmitted through the second transmission antenna, defined by x₂^{k+1}=[0,0, . . . ,0], and transmission symbol streams to be transmitted through the third transmission antenna, defined by x₃^{k+1}=└−s₁^{k*}(0),−s₁^{k*}(N−1), . . . ,s₁^{k*}(1)┘.

27. The method as claimed in claim 19, wherein, in step (2), when the modulation symbol streams include N number of modulation symbols, M_{T}=3, and the iteration number of transmission corresponds to an even number (k+1=2, 4, 6, . . . ), which implies an even^{th} transmission of the information data bit stream, a space-time block coding scheme is determined as the space-time encoding scheme, so that the three transmission symbol streams are generated by space-time encoding the transmission symbol streams having been transmitted in the odd^{th} transmission (k=1, 3, 5, . . . ) of the information data bit stream according to the space-time block coding scheme, wherein:
the transmission symbol streams having been transmitted in the odd^{th} transmission of the information data bit stream comprises transmission symbol streams transmitted through the first transmission antenna, defined by x₁^{k}=└s₁^{k}(0),s₁^{k}(1), . . . ,s₁^{k}(N−1)┘, transmission symbol streams transmitted through the second transmission antenna, defined by x₂^{k}=└s₂^{k}(0),s₂^{k}(1), . . . ,s₂^{k}(N−1)┘, and transmission symbol streams transmitted through the third transmission antenna, defined by x₃^{k}=└s₃^{k}(0),s₃^{k}(1), . . . ,s₃^{k}(N−1)┘; and
the transmission symbol streams to be transmitted in the event^{th} transmission of the information data bit stream comprises transmission symbol streams to be transmitted through the first transmission antenna, defined by x₁^{k+1}=[0,0, . . . ,0], transmission symbol streams to be transmitted through the second transmission antenna, defined by x₂^{k+1}=└−s₃^{k*}(0),−s₃^{k*}(N−1), . . . ,−s₃^{k*}(1)┘, and transmission symbol streams to be transmitted through the third transmission antenna, defined by x₃^{k+1}=└s₂^{k*}(0),s_{k*}(N−1), . . . ,s₂^{k*}(1)┘.

28. A method for receiving a signal by a signal reception apparatus in a communication system, the method comprising the steps of:
(1) receiving signals transmitted through M_{T} number of transmission antennas of a signal transmission apparatus corresponding to the signal reception apparatus, and performing FFT on the received signals;
(2) generating an incoming signal vector by linearly combining the FFTed signals, detecting signals from the incoming signal vector according to a predetermined signal detection scheme, and separately outputting M_{T} number of detected signals in accordance with the M_{T} transmission antennas of the signal transmission apparatus;
(3) performing IFFT on the M_{T} detected signals; and
(4) demodulating the IFFTed signals according to a demodulation scheme corresponding to a modulation scheme used in the signal transmission apparatus.

29. The method as claimed in claim 28, further comprising the steps of:
converting the demodulated signals to a serial signal;
decoding the converted serial signal according to a decoding scheme corresponding to a coding scheme used in the signal transmission apparatus.

30. The method as claimed in claim 29, further comprising the step of transmitting NACK information to the signal transmission apparatus when there is an error in the information data bit stream transmitted from the signal transmission apparatus, wherein the NACK information indicates that there is an error in the information data bit stream.

31. The method as claimed in claim 30, wherein, in step (2), when there is a previously detected signal for the same information data stream, the previously detected signal and a currently detected signal are combined together and a combined signal is then output.

32. The method as claimed in claim 28, wherein the signal detection scheme includes a Minimum Mean Square Error (MMSE) scheme and a Zero Forcing (ZF) scheme.
